(19) United States
(12) Patent Application Publication
(10) Pub. No.: US 2023/0229938 A1
(43) Pub. Date: Jul. 20, 2023

(54) SYSTEMS AND METHODS FOR INTEGRATION OF MACHINE LEARNING MODELS WITH CLIENT APPLICATIONS

(71) Applicant: FMR LLC, Boston, MA (US)

(72) Inventors: John Mariano, Plymouth, MA (US); David Johnston, Dublin (IE); Vall Herard, Upper Nyack, NY (US); Jason Matthew Megaro, Northborough, MA (US)

(21) Appl. No.: 18/098,397

(22) Filed: Jan. 18, 2023

Related U.S. Application Data
(60) Provisional application No. 63/300,457, filed on Jan. 18, 2022.

(51) Int. Cl. G06N 5/022; G06F 9/54

(52) U.S. Cl. CPC G06N 5/022; G06F 9/547

(57) ABSTRACT

Systems and methods are described for integrating one or more machine learning models with a client application using Remote Procedure Calls (RPCs). A server deploys a software container associated with a client application, the container comprising executable code corresponding to a machine learning model, a plurality of inputs to the machine learning model, and a plurality of outputs of the machine learning model. The server generates a protocol buffer profile using the inputs and the outputs, the protocol buffer profile defining RPC functions for integrating the client application and the machine learning model. The server receives, from the client application, a request to access the machine learning model using a first RPC function. The server executes the machine learning model to generate a classification value for input provided in the request. The server transmits the classification value to the client application using a second RPC function.

### RELATED APPLICATIONS

This application claims priority to U.S. Provisional Patent Application No. 63/300,457, filed on Jan. 18, 2022, the entirety of which is incorporated herein by reference.

### TECHNICAL FIELD

The present invention relates generally to systems and methods for integrating machine learning models with client applications, including systems and methods for using machine learning models to detect patterns in various forms of media.

### BACKGROUND

A number of present-day problems act to hold back progress in the fields of artificial intelligence and machine learning. Among the most serious issues is the difficulty of integrating artificial intelligence and machine learning solutions with large-scale applications and systems and providing a means to rapidly change or adapt artificial intelligence and machine learning solutions to changes in data and/or market requirements. Therefore, there is a need for a framework for integration of artificial intelligence and machine learning solutions that can be used by data scientists and engineers to implement containerized models with large-scale systems.

### SUMMARY

Accordingly, an object of the invention is to provide systems and methods for integrating one or more machine learning (ML) classification models with a client application. It is an object of the invention to provide systems and methods for integrating one or more machine learning models with a client application using Remote Procedure Calls (RPCs). It is an object of the invention to provide systems and methods for generating a protocol buffer from a container image corresponding to a client application. It is an object of the invention to provide systems and methods for defining an API message based on a protocol buffer profile associated with a container image. It is an object of the invention to provide systems and methods for transmitting an API message based on a protocol buffer profile associated with a container image to a client application.

The techniques described herein advantageously conventionalize model development and integration with an application. By utilizing CI/CD processes, containerized software deployment, and RPC functionality, software engineers and data scientists can use the same development pipeline to build, deploy, and update the integration of ML models with their applications. The methods and systems described herein can beneficially execute multiple different ML models at once within a single client application in real time or near real time—without the need for separate infrastructure, processing/integration logic, or model operations.

When scaling forward, the techniques beneficially scale both horizontally and vertically. Utilizing the RPC client/server approach described herein, the costly overhead of REST/FLASK APIs is eliminated and the ability to rapidly scale and fully leverage containerized ML models is realized. Also, the integration, deployment, and execution of ML models with client applications can be configured by a non-technical resource without requiring specific DevOps or ModelOps skills. Finally, the systems and methods are executed and managed on cloud computing resources via containers—which deftly handles model workload fluctuations by exploiting both horizontal and vertical elasticity (e.g., configuration, autoscaling) of such resources.

The invention, in one aspect, features a computerized method of integrating one or more machine learning models with a client application using Remote Procedure Calls (RPCs). A server computing device deploys a software container associated with a client application, the software container comprising executable code corresponding to a machine learning model of a plurality of machine learning models, a plurality of inputs to the machine learning model, and a plurality of outputs of the machine learning model. The server computing device generates a protocol buffer profile using the inputs of the machine learning model and the outputs of the machine learning model, the protocol buffer profile defining one or more RPC functions for integrating the client application and the machine learning model. The server computing device receives, from the client application, a request to access the machine learning model using a first one of the RPC functions. The server computing device executes the machine learning model to generate a classification value for input provided in the request. The server computing device transmits the classification value to the client application using a second one of the RPC functions.

The invention, in another aspect, features a system for integrating one or more machine learning models with a client application using Remote Procedure Calls (RPCs). The system includes a server computing device with a memory for storing computer executable instructions and a processor that executes the computer executable instructions. The server computing device deploys a software container associated with a client application, the software container comprising executable code corresponding to a machine learning model of a plurality of machine learning models, a plurality of inputs to the machine learning model, and a plurality of outputs of the machine learning model. The server computing device generates a protocol buffer profile using the inputs of the machine learning model and the outputs of the machine learning model, the protocol buffer profile defining one or more RPC functions for integrating the client application and the machine learning model. The server computing device receives, from the client application, a request to access the machine learning model using a first one of the RPC functions. The server computing device executes the machine learning model to generate a classification value for input provided in the request. The server computing device transmits the classification value to the client application using a second one of the RPC functions.

Any of the above aspects can include one or more of the following features. In some embodiments, the first RPC function comprises an RPC request function for providing input to the machine learning model. In some embodiments, receiving a request to access the machine learning model comprises receiving, by an RPC server module of the server computing device, the request to access the machine learning model from an RPC client module of the client application, and mapping, by the RPC server module, the input provided in the request to one or more input parameters for the machine learning model.

In some embodiments, the second RPC function comprises an RPC response function for providing the classification value from the machine learning model. In some embodiments, transmitting the classification value to the client application comprises mapping, by the RPC server module, the classification value provided by the machine learning model to an output parameter of the second RPC function, and executing, by the RPC server module, the second RPC function to transmit the output parameter to the RPC client module of the client application.

In some embodiments, the input provided in the request comprises a corpus of unstructured text. In some embodiments, the classification value provided by the machine learning model comprises indicia of whether the unstructured text complies with one or more rulesets. In some embodiments, the machine learning model generates one or more labels each associated with a portion of the unstructured text, each label designating a compliance type for the corresponding portion of text. In some embodiments, the machine learning model further generates a confidence level associated with the classification value, the confidence level designating a certainty with which the machine learning model considers the classification value as accurate or inaccurate.

In some embodiments, each of the plurality of machine learning models corresponds to a different classification task. In some embodiments, the protocol buffer profile associates each of the one or more RPC functions with a corresponding application programming interface (API) call for interacting with the machine learning model.

Other aspects and advantages of the invention can become apparent from the following drawings and description, all of which illustrate the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for integrating one or more machine learning models with a client application using Remote Procedure Calls (RPC).

FIG. 2 is a flow diagram of a computerized method of integrating one or more machine learning models with a client application using Remote Procedure Calls (RPC).

FIG. 3 is a diagram of an exemplary user interface for generating and deploying a model container for a machine learning model at a server computing device.

FIG. 4 is a diagram of an exemplary user interface for designating a model type for a machine learning model prior to deployment in a model container.

FIG. 5 is a diagram of an exemplary user interface for assigning model settings for a machine learning model prior to deployment in a model container.

FIG. 6 is a flow diagram of a machine learning model development pipeline.

### DETAILED DESCRIPTION OF THE INVENTION

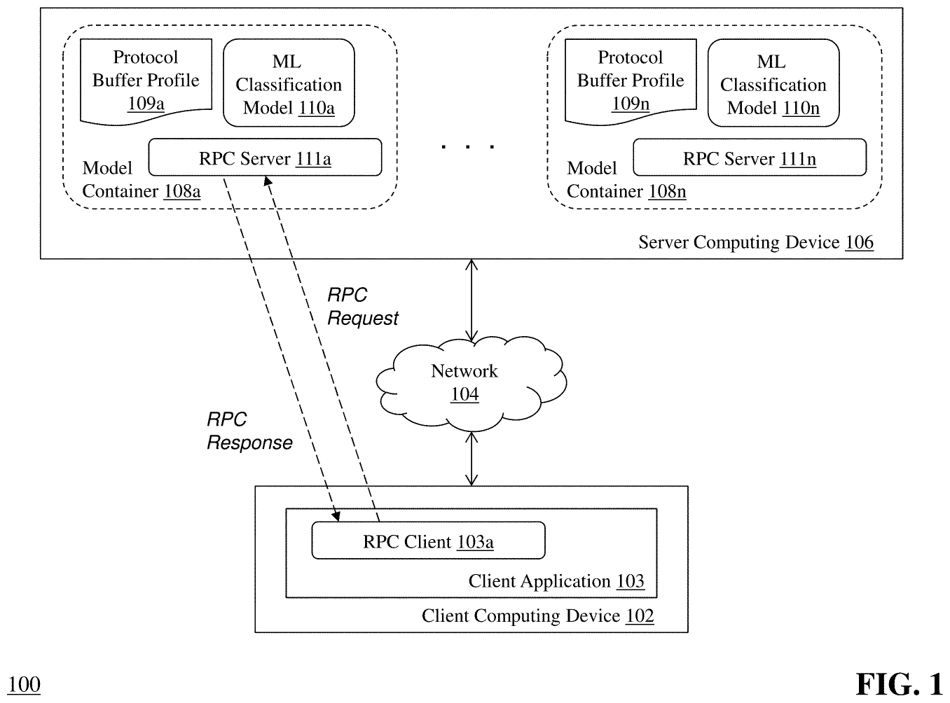

FIG. 1 is a block diagram of system 100 for integrating one or more machine learning models with a client application using Remote Procedure Calls (RPC). System 100 includes client computing device 102 with client application 103 that has an RPC client module 103a, communications network 104, server computing device 106 with a plurality of model containers 108a-108n. Each model container 108a-108n includes a protocol buffer profile 109a-109n (also called a protobuf profile), a machine learning (ML) classification model 110a-110n, and a RPC server module 111a-111n, respectively.

Client computing device 102 connects to one or more communications networks (e.g., network 104) in order to communicate with server computing device 106 relating to the integration of one or more ML models with a client application as described herein. Exemplary client computing devices 102 include but are not limited to server computing devices, desktop computers, laptop computers, tablets, mobile devices, smartphones, and the like. It should be appreciated that other types of computing devices that are capable of connecting to the components of system 100 can be used without departing from the scope of invention. Although FIG. 1 depicts a single client computing device 102, it should be appreciated that system 100 can include any number of client computing devices. Client computing device 102 is configured with client application 103. Generally, client application 103 is any type of software that a developer wishes to integrate with machine learning models 110a-110n as made available by server computing device 106. For purposes of this specification, an exemplary type of client application 103 is compliance monitoring software that processes and analyzes computer files (e.g., digital documents, structured or unstructured text, chat logs, messages, image files, video files, etc.) for the purpose of evaluating whether content of the computer files complies with one or more rulesets. As part of the analysis, client application 103 integrates the machine learning functionality of server computing device 106 to perform one or more tasks, such as automated classification of content in the computer files as compliant or non-compliant and/or labeling of portions of the content according to a type of compliance or non-compliance. (e.g., exaggerated, misleading, promissory, etc.). Typically, the computer files relate to a particular domain (e.g., financial services, investment, healthcare) for which compliance with one or more rulesets (e.g., governmental or industry regulations) is required. One or more of the machine learning classification models 110a-110n can be configured to analyze input content and automatically provide a classification of the input content (i.e., a label). In some embodiments, ML models 110a-110n are defined as pattern matchers which compare patterns of sentences, or patterns of words within sentences, in unlabeled documents against known compliant or non-compliant patterns and generate a classification value for the document and/or each sentence in the document. An example compliance label can be a binary value (e.g., 0 for non-compliant, 1 for compliant), an alphanumeric value (e.g., indicating the compliance result and one or more applicable rulesets), or other types of labeling mechanisms. Client application 103 includes RPC client module 103a. RPC client module 103a is a specialized network communication interface software module configured to execute RPC request functions which transmit data via network 104 to RPC server modules 111a-111n of server computing device 106 and to receive corresponding RPC responses from RPC server modules 111a-111n.

Communications network 104 enables client computing device 102 to communicate with server computing device 106. Network 104 is typically comprised of one or more wide area networks, such as the Internet and/or a cellular network, and/or local area networks. In some embodiments, network 104 is comprised of several discrete networks and/or sub-networks (e.g., cellular to Internet).

Server computing device 106 is a device including specialized hardware and/or software modules that execute on one or more processors and interact with memory modules of server computing device 106, to receive data from other components of system 100, transmit data to other components of system 100, and perform functions for integrating one or more machine learning models with a client application using Remote Procedure Calls (RPC) as described herein. Server computing device 106 includes a plurality of model containers 108a-108n each containing a protocol buffer profile 109a-109n, a ML classification model 110a-110n, and a RPC server module 111a-111n that execute on one or more processors of server computing device 106. In some embodiments, model containers 108a-108n are specialized sets of computer software instructions programmed onto one or more dedicated processors in server computing device 106.

In some embodiments, model containers 108a-108n each comprise a software image (i.e., software code files, environment variables, libraries, other dependencies, and the like) and a data set (i.e., data files and/or a local database). Server computing device 106 can be configured to execute many software containers, in isolation from each other, that access a single operating system (OS) kernel. Server computing device 106 executes each software container in a separate OS process and constrains each container's access to physical resources (e.g., CPU, memory) of server computing device 106 so that a single container does not utilize all of the available physical resources. Upon execution, server computing device 106 executes the software application code stored in one or more of the model containers 108a-108n to, e.g., launch RPC server module 111a-111n and make the corresponding ML classification model 110a-110n available to downstream computing applications (e.g., client application 103 of device 102) using Remote Procedure Calls defined by the associated protocol buffer profile 109a-109n for the container. In some embodiments, model containers 108a-108n can be deployed on commodity hardware in a proprietary environment or a commercially available cloud container environment, such as Amazon® AWS™, Microsoft® Azure™, Rackspace™ Managed Hosting, and the like. Also, server computing device 106 can utilize one or more container orchestration and development platforms to create and deploy model containers 108a-108n such as Kubernetes™, Docker™, etc. One or two-way SSL encryption can be used for transfer of data between client computing device 102 and server computing device 106.

Protocol buffer profiles 109a-109n comprise programmatic instructions that define the communication structure between client application 103 and the corresponding ML classification model 110a-110n via RPC client 103a and RPC server 111a-111n. In some embodiments, protobuf profiles 109a-109n define the interaction on inputs and outputs to the associated ML model 110a-110n in the container 108a-108n. For example, an ML model 110a-110n may be designed or structured to communicate via application programming interface (API) calls. Protobuf profiles 109a-109n advantageously define these API calls in message format (i.e., as RPC functions)—essentially exposing the ML model 110a-110n via RPC server module 111a-111n such that developers can integrate the RPC functions directly into client application 103 via RPC client module 103a. Thus, each protocol buffer profile 109a-109n allows for serialization of communications between client application 103 and model 110a-110n which—as will be described in detail below—greatly improves the ability for client applications to leverage machine learning models by streamlining the application development process and making communication between applications and models more efficient through the use of RPCs.

Machine learning (ML) classification models 110a-110n are trained machine learning (ML) algorithms that receive input from client application 103 and analyze the input to generate corresponding output, most often a classification and/or label of the input according to a particular framework. As set forth previously, one example of such ML processing is the classification/labeling of digital files or documents for compliance with one or more rulesets. In this example, an ML model 110a-110n can be trained on an existing corpus of labelled documents. Then, when an unlabeled document is provided to ML model 110a-110n as input, the model can analyze the document and generate a classification for the document (i.e., compliant or non-compliant). Model container 108a-108n can return the classification to the client application 103 that provided the unlabeled document. In some embodiments, ML models 110a-110n can also generate a confidence level associated with the classification value. For example, an ML model 110a-110n may encounter content in an input document that it is unable to properly analyze and/or classify (e.g., if the model was not trained on sufficient examples of that type of content). In these cases, ML model 110a-110n may still be able to generate a classification value but also determine that a confidence level associated with the classification value is low. Conversely, when ML model 110a-110n analyzes a document and is able to generate a corresponding classification value with a high degree of certainty, the model can return a high confidence level.

It should be appreciated that the functionality of model containers 108a-108n can be distributed on a single server computing device (e.g., server computing device 106) or on a plurality of server computing devices. It should be appreciated that any number of computing devices, arranged in a variety of architectures, resources, and configurations (e.g., cluster computing, virtual computing, cloud computing, SaaS, etc.) can be used without departing from the scope of the invention.

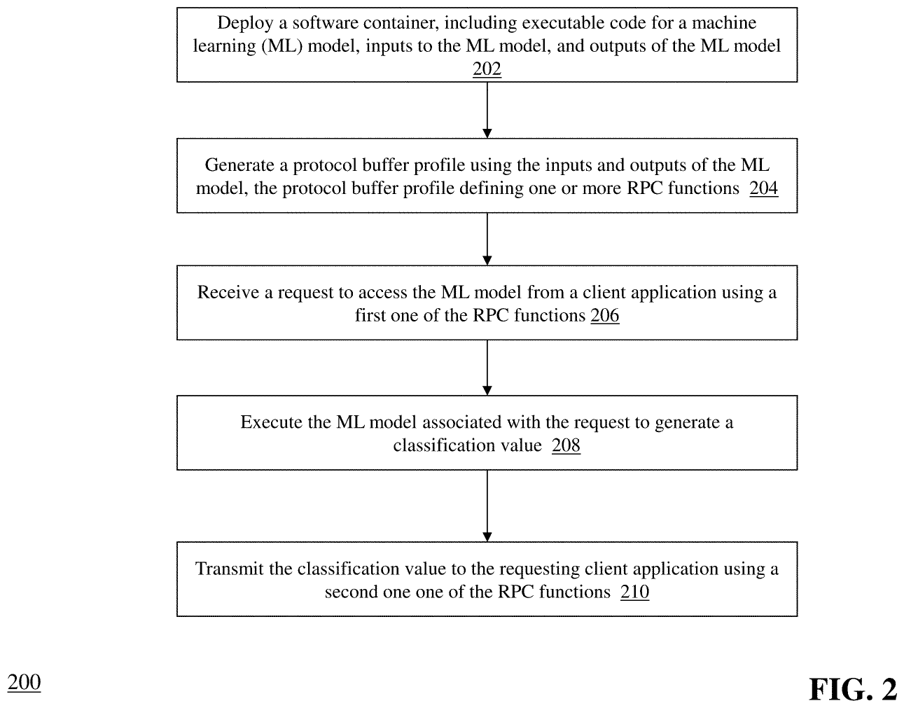

FIG. 2 is a flow diagram of a computerized method 200 of integrating one or more machine learning models with a client application using Remote Procedure Calls (RPC) using system 100 of FIG. 1. Server computing device 106 deploys (step 202) a software container (e.g., container 108a) that includes executable code for a machine learning (ML) model (e.g., classification model 110a), inputs to the ML model, and outputs to the ML model. In some embodiments, server computing device 106 generates the software container using an image upon receiving instructions from a remote computing device. For example, a developer or administrator at a remote computing device may utilize a user interface module to connect to server computing device 106 and provide instructions to define a new model container using a particular type of ML classification model.

Once the model container 108a is deployed, server computing device 106 generates (step 204) a protocol buffer profile 109a from the model container 108a image. As described above, protocol buffer profile 109a defines one or more Remote Procedure Call (RPC) functions for interactions between ML classification model 110a and a consuming client application (e.g., application 103) using the RPC server module 111a and RPC client module 109a. For example, protocol buffer profile 109a can map an RPC request function to an input API call for ML classification model 110a that includes one or more input parameters. Protocol buffer profile 109a can map an RPC response function to an API response call returned from ML classification model 110a that includes output parameters from execution of the model. In some embodiments, protocol buffer profile 109a is stored as a data set or file in model container 108a.

A developer or data scientist can then integrate the RPC functions into client application 103 for the purpose of utilizing ML model 110a as part of the application. RPC client module 103a of client application 103 establishes a connection to server computing device 106 and client application 103 calls the RPC client module 103a using an RPC request function (as defined in protocol buffer profile 109a) to submit a request to RPC server module 111a to access ML classification model 110a. In some embodiments, the RPC request function includes one or more parameters to be used as input to ML classification model 110a—example parameters include:

DOCUMENT=text string, document, and/or file that ML model 110a will analyze for classification, and

THRESHOLD=numeric value used by ML model 110a for classification, i.e., the value used to convert logistic regression output from model 110a to a binary classification value. For example, when the THRESHOLD is set to 0.5, model output values at or above 0.5 are classified as ‘compliant’ while model output values below 0.5 are classified as ‘non-compliant.’

RPC server module 111a of model container 108a receives (step 206) the request to access ML classification model 110a from RPC client module 103a that was generated using the RPC request function. Using protocol buffer profile 109a, RPC server module 111a converts the RPC request function parameters to corresponding input parameters for ML classification model 110a. As mentioned above, in some embodiments protocol buffer profile 109a exposes functions to ML model 110a for inputs and outputs and maps these functions to client application 103.

Model container 108a executes (step 208) ML classification model 110a using the input received from client application 103 (i.e., STRING and THRESHOLD parameters) to generate a classification value for the input text. In some embodiments, ML model 110a generates output parameters such as:

CLASSIFICATION=classification value determined by ML model 110a for the input DOCUMENT (in some embodiments, this is a binary value or other indicia that informs client application 103 whether the input is compliant or non-compliant),

LABEL=additional classification data for the input DOCUMENT, such as a grouping or type that provides information about the characteristics or features of DOCUMENT that relate to the classification value, and

CONFIDENCE_VALUE=an indicator as to the certainty with which ML model 110a considers the generated classification value as accurate or inaccurate.

As can be appreciated, model container 108a can execute ML model 110a immediately upon receiving the request from client application 103 and provide the output to client application 103 when the model execution is complete. In some embodiments, model container 108a can execute ML model 110a asynchronously from receipt of the request from client application 103.

RPC server module 111a receives the output parameters from ML model 110a and converts the output parameters to an RPC response message using protocol buffer profile 109a. In some embodiments, RPC server module 111a generates a two-dimensional (2D) array or other type of data structure that contains the output parameters. RPC server module 111a transmits (step 210) the output, including the classification value generated by ML model 110a, to RPC client module 103a using the RPC response message. RPC client module 103a provides the output to client application 103 for subsequent analysis and processing, e.g., as part of a larger application workflow.

In some embodiments, client application 103 can be configured to communicate with a plurality of different model containers 108a-108n and ML models 110a-110n. For example, client application 103 can send the same document to multiple ML models 110a-110n for classification and aggregate the classification values returned by each model to generate an overall classification value for the document. In another example, each ML model 110a-110n can be designed to analyze and classify different types of documents or text, or to apply different compliance rulesets to the input document to generate a spectrum of compliance determinations. As can be appreciated, the same techniques as described above can apply to the connection between client application 103 and each of the plurality of ML models 110a-110n that the client application 103 employs.

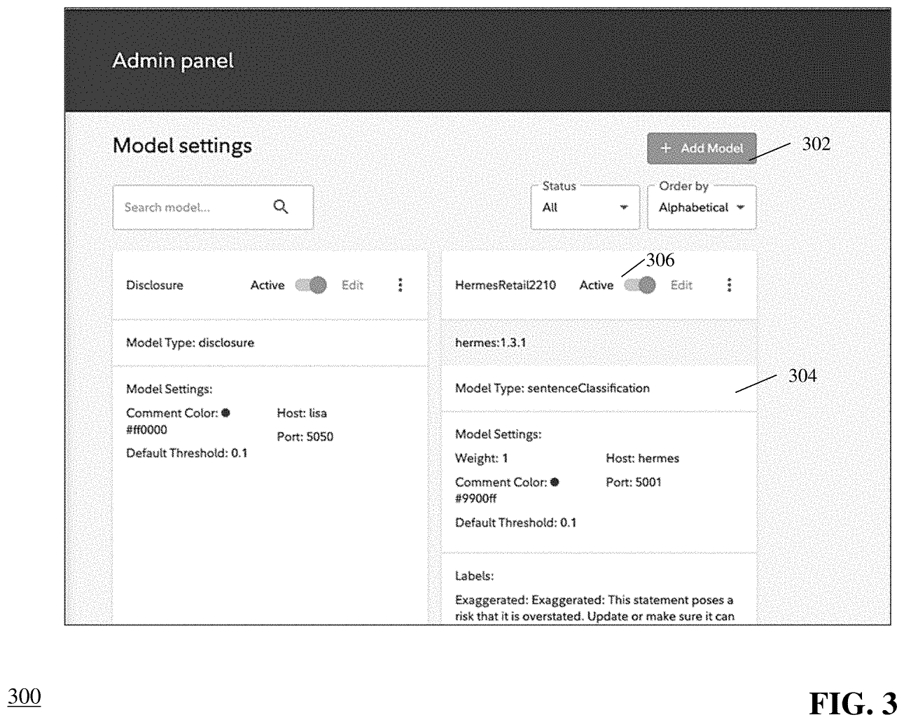

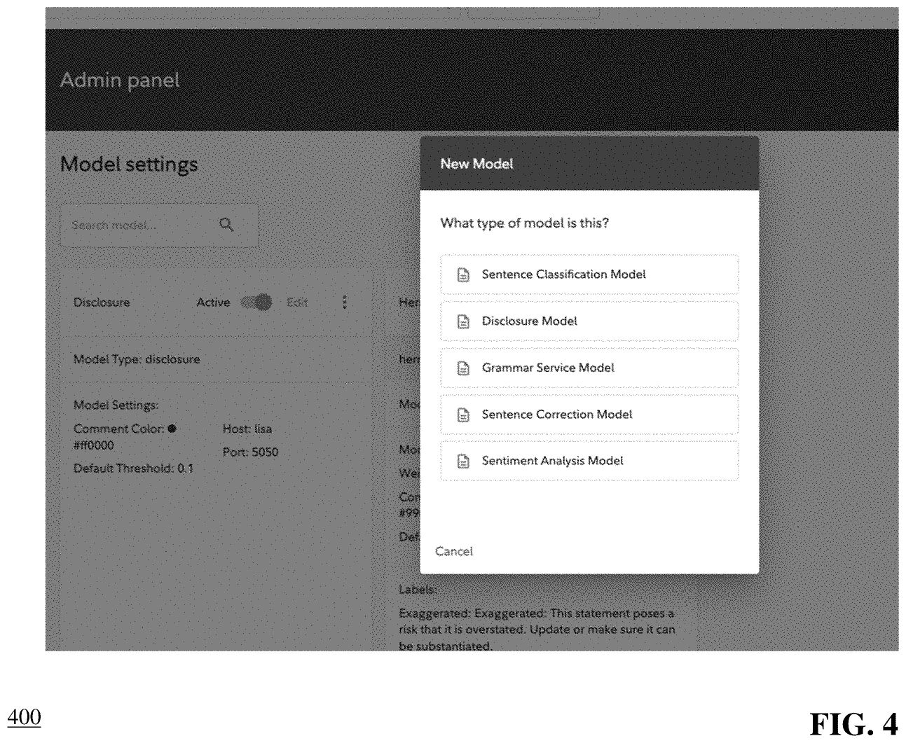

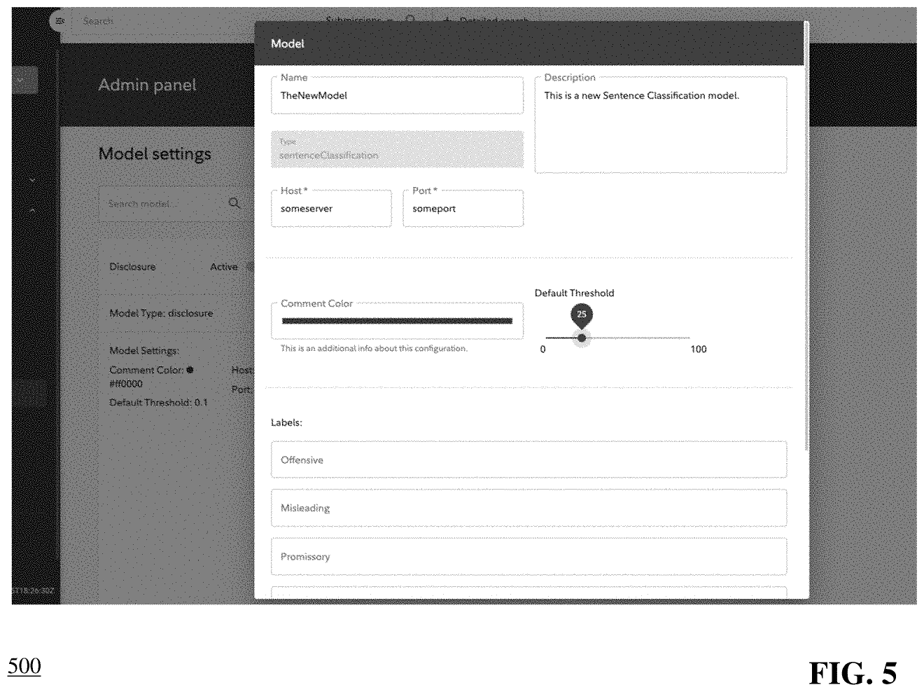

As mentioned previously, a developer or administrator at a remote computing device may utilize a user interface module to connect to server computing device 106 and provide instructions to define a new model container using a particular type of ML classification model. FIG. 3 is a diagram of an exemplary user interface 300 for generating a model container 108a-108n for ML model 110a-110n at server computing device 106. As shown in FIG. 3, the user can select the add model button 302 and configure specific model settings 304 (including model type, weights, host server, port, labels, threshold, etc.). FIG. 4 is a diagram of an exemplary user interface 400 for designating a model type for ML model 110a-110n prior to deployment in model container 108a-108n. As shown in FIG. 4, the user can select one of a number of different existing ML models 110a-110n (e.g., Sentence Classification, Disclosure, Grammar Service, Sentence Correction, Sentiment Analysis) for integration with their client application 103. FIG. 5 is a diagram of an exemplary user interface 500 for assigning model settings for ML model 110a-110n prior to deployment in model container 108a-108n. As shown in FIG. 5, the user can assign values for different settings for the model, such as name, description, host, port, threshold, labels, and so forth.

Turning back to FIG. 3, the user can also use a toggle button 306 for each model to indicate whether server computing device 106 should proceed to deploy the new model in a model container 108a (i.e., ‘Active’). As can be appreciated, when an ML classification model 110a-110n is no longer needed (e.g., the corresponding client application 103 is being removed), the user can toggle the button 306 from Active to Inactive. In some embodiments, server computing device 106 can disable or remove the corresponding container 108a from execution.

As can be appreciated, the systems and methods described herein advantageously enable independent development and modification of client applications and machine learning models used by such applications. Once a model container 108a with associated protocol buffer profile and ML models 110a-110n are created, the models can be continually updated, improved, retrained, and changed without requiring any corresponding software changes in client applications (such as application 103) because the RPC call infrastructure embodied in RPC server module 111a-111n and RPC client module 103a does not change. RPC server module 111a-111n starts up in a corresponding model container 108a-108n and receives a request from client application 103. Module 111a-111n formulates a corresponding execution request for ML model 110a-110n (transforming the input data if necessary), while also supporting encoding of data to ensure standardization of information between models 110a-110n and client application 103. Furthermore, the RPC server-client interface is the sole integration point between the client application 103 and the ML model 110a-110n, thereby providing flexibility for different requirements or needs and eliminating complicated model operations or model changes. Utilizing RPC, communication between client computing device 102 and server computing device 106 is highly efficient—typically providing 7-10× performance improvement over standard API calls. Additionally, the level of application and model integration described herein streamlines the application development process for data scientists and programmers because no specialized DevOps or ModelOps skills are necessary. As a result, the need for development time and/or skills devoted to model operations or model integrations is eliminated.

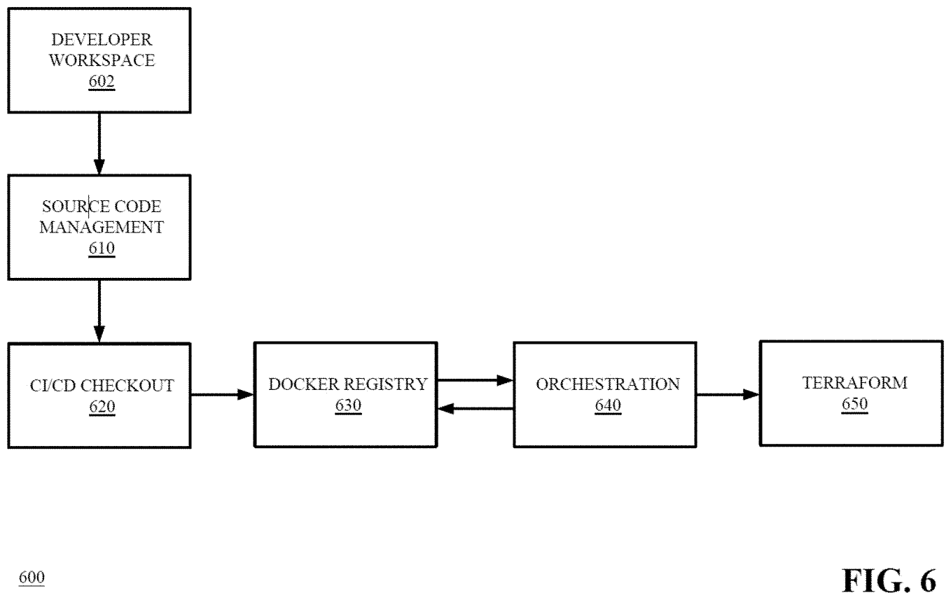

The techniques described herein also provide for a model development and deployment pipeline. FIG. 6 is a flow diagram of an ML model pipeline 600 using system 100. Model pipeline 600 includes developer workspace 602, source code management 610, CI/CD checkout 620, docker registry 630, orchestration module 640, and terraform module 650. Developers can use developer workspace 602 to push source code to source code management 610. Source code management 610 can be implemented using bitbucket or any other private code repository. CI/CD checkout 620 can then be used for continuous integration and continuous development checks. For example, in some embodiments, Jenkins™ can be used to integrate changes to source code, SonarQube™ can be used for inspection of code quality, and Veracode™ can be used as a source code security analyzer.

Docker registry 630 can use a docker image or read-only template that contains instructions on creating a model container that can run the docker platform. In some embodiments, Artifactory™ is used to store one or more docker images as binary artifacts. Orchestration module 640 can be implemented using Nomad™ and allows for deployment and management of containerized applications. Terraform module 450 is a tool used for building, changing, and versioning source code, as well as deploying to the cloud.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The above-described techniques can be implemented using supervised learning and/or machine learning algorithms. Supervised learning is the machine learning task of learning a function that maps an input to an output based on example input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method of integrating one or more machine learning models with a client application using Remote Procedure Calls (RPCs), the method comprising:
deploying, by a server computing device, a software container associated with a client application, the software container comprising executable code corresponding to a machine learning model of a plurality of machine learning models, a plurality of inputs to the machine learning model, and a plurality of outputs of the machine learning model;
generating, by the server computing device, a protocol buffer profile using the inputs of the machine learning model and the outputs of the machine learning model, the protocol buffer profile defining one or more RPC functions for integrating the client application and the machine learning model;
receiving, by the server computing device from the client application, a request to access the machine learning model using a first one of the RPC functions;
executing, by the server computing device, the machine learning model to generate a classification value for input provided in the request; and
transmitting, by the server computing device, the classification value to the client application using a second one of the RPC functions.

2. The method of claim 1, wherein the first RPC function comprises an RPC request function for providing input to the machine learning model.

3. The method of claim 2, wherein receiving a request to access the machine learning model comprises:
receiving, by an RPC server module of the server computing device, the request to access the machine learning model from an RPC client module of the client application; and
mapping, by the RPC server module, the input provided in the request to one or more input parameters for the machine learning model.

4. The method of claim 3, wherein the second RPC function comprises an RPC response function for providing the classification value from the machine learning model.

5. The method of claim 4, wherein transmitting the classification value to the client application comprises:
mapping, by the RPC server module, the classification value provided by the machine learning model to an output parameter of the second RPC function; and
executing, by the RPC server module, the second RPC function to transmit the output parameter to the RPC client module of the client application.

6. The method of claim 1, wherein the input provided in the request comprises a corpus of unstructured text.

7. The method of claim 6, wherein the classification value provided by the machine learning model comprises indicia of whether the unstructured text complies with one or more rulesets.

8. The method of claim 7, wherein the machine learning model generates one or more labels each associated with a portion of the unstructured text, each label designating a compliance type for the corresponding portion of text.

9. The method of claim 8, wherein the machine learning model further generates a confidence level associated with the classification value, the confidence level designating a certainty with which the machine learning model considers the classification value as accurate or inaccurate.

10. The method of claim 1, wherein each of the plurality of machine learning models corresponds to a different classification task.

11. The method of claim 1, wherein the protocol buffer profile associates each of the one or more RPC functions with a corresponding application programming interface (API) call for interacting with the machine learning model.

12. A system for integrating one or more machine learning models with a client application using Remote Procedure Calls (RPCs), the system comprising a server computing device having a memory for storing computer executable instructions and a processor that executes the computer executable instructions to:
deploy a software container associated with a client application, the software container comprising executable code corresponding to a machine learning model of a plurality of machine learning models, a plurality of inputs to the machine learning model, and a plurality of outputs of the machine learning model;
generate a protocol buffer profile using the inputs of the machine learning model and the outputs of the machine learning model, the protocol buffer profile defining one or more RPC functions for integrating the client application and the machine learning model;
receive, from the client application, a request to access the machine learning model using a first one of the RPC functions;
execute the machine learning model to generate a classification value for input provided in the request; and
transmit the classification value to the client application using a second one of the RPC functions.

13. The system of claim 12, wherein the first RPC function comprises an RPC request function for providing input to the machine learning model.

14. The system of claim 13, wherein receiving a request to access the machine learning model comprises:
receiving, by an RPC server module of the server computing device, the request to access the machine learning model from an RPC client module of the client application; and
mapping, by the RPC server module, the input provided in the request to one or more input parameters for the machine learning model.

15. The system of claim 14, wherein the second RPC function comprises an RPC response function for providing the classification value from the machine learning model.

16. The system of claim 15, wherein transmitting the classification value to the client application comprises:
mapping, by the RPC server module, the classification value provided by the machine learning model to an output parameter of the second RPC function; and
executing, by the RPC server module, the second RPC function to transmit the output parameter to the RPC client module of the client application.

17. The system of claim 12, wherein the input provided in the request comprises a corpus of unstructured text.

18. The system of claim 17, wherein the classification value provided by the machine learning model comprises indicia of whether the unstructured text complies with one or more rulesets.

19. The system of claim 18, wherein the machine learning model further generates one or more labels each associated with a portion of the unstructured text, each label designating a compliance type for the corresponding portion of text.

20. The system of claim 19, wherein the machine learning model further generates a confidence level associated with the classification value, the confidence level designating a certainty with which the machine learning model considers the classification value as accurate or inaccurate.

21. The system of claim 12, wherein each of the plurality of machine learning models corresponds to a different classification task.

22. The system of claim 12, wherein the protocol buffer profile associates each of the one or more RPC functions with a corresponding application programming interface (API) call for interacting with the machine learning model.
